(19) United States
(12) Patent Application Publication
(10) Pub. No.: US 2006/0262013 A1
(43) Pub. Date: Nov. 23, 2006

(54) FULL-DUPLEX DUAL-FREQUENCY SELF-STEERING ARRAY USING PHASE DETECTION & PHASE SHIFTING

(76) Inventors: Grant S. Shiroma, Hilo, HI (US); Wayne A. Shiroma, Kaneohe, HI (US); Ryan Y. Miyamoto, Honolulu, HI (US)

Correspondence Address: Leighton K. Chong;Godbey Griffiths Reiss & Chong, Pauahi Tower, Suite 2300, 1001 Bishop Street, Honolulu, HI, 96813, US

(21) Appl. No.: 11/383,453

(22) Filed: May 15, 2006

Related U.S. Application Data
(60) Provisional application No. 60/683,124, filed on May 18, 2005.

(51) Int. Cl. H01Q 1/00

(52) U.S. Cl. 342/370

(57) ABSTRACT

A self-steering retrodirective array capable of both full-duplex communication and maintaining a constant retrodirected power level uses an angle-detecting array with a phase detector to detect the angle of the incoming signal from a source and generate an error voltage signal, and a transmitting array having a phase shifter controlled by the error voltage signal to retrodirect a beam back in the direction of the source. A phase shifter in the receiving array also ensures coherent combination of the incoming signal. The angle-detection array and transmitter array are RF-decoupled for full-duplex communication. The efficiency of the system is increased by using an interrogator signal at a much lower frequency than the transmitted signal. In a preferred embodiment, a simple two-element angle detecting array detects the direction of the source. Since the source angle is determined by measuring the phase difference between the two antenna elements, the angle detecting array is insensitive to the type of modulation used for the incoming signal.

This U.S. Patent Application claims the priority of U.S. Provisional Patent Application 60/683,124 entitled “Low Cost Self-Steering Array Capable of Constant Transmit Power and Full-Duplex Communication”, by the same inventors, filed on May 18, 2005.

The subject matter of this U.S. patent application was supported in part by the University Nanosat Program administered by the Air Force Office of Scientific Research, Contract No. F49620-03-1-0121. The U.S. Government has certain rights in the invention.

### TECHNICAL FIELD

This invention relates to retrodirective arrays which can transmit a return signal in the direction of an initial or interrogator signal, and particularly to a self-steering retrodirective array using phase detection and phase shifting to obtain constant transmit power and full-duplex communication.

### BACKGROUND OF INVENTION

Retrodirective arrays have attracted a great deal of interest for their self-steering capabilities in solar power satellite systems (SPS), radio frequency identification (RFID), collision avoidance sensors, and small-satellite networks. These arrays have the unique property that when the array is interrogated, the array automatically points its return signal beam towards the interrogator. In contrast to conventional beam steering in phased-array systems, a retrodirective array is self-steering and does not require digital signal processing like smart antenna systems. As a result, it is an attractive alternative for simple, low-cost systems. The Van Atta and heterodyne phase-conjugating architectures are the conventional methods for realizing a retrodirective array. However, there are several issues regarding the overall efficiency of both implementations that require additional attention before a retrodirective array can be successfully integrated into a practical system. First, for a retrodirective array to operate both efficiently and cost effectively, it must be capable of full-duplex communication (i.e., simultaneous, two-way data transmission), with minimal added circuit complexity. However, most reported retrodirective arrays are only capable of simplex communication (i.e., one-way data transmission based on an unmodulated interrogating signal). Two-way communication using two simplex arrays would require the use of two separate unmodulated interrogating signals, resulting in a very inefficient system.

In prior publications, full-duplex BPSK communication was achieved by downconverting the incoming RF signal with a mixer and then separating the message and geometry phase. The remaining IF signal containing the phase-conjugated geometry phase was then modulated and upconverted by a second mixer. While this design achieved full-duplex communication, it required special phase-filtering circuits, as well as two mixers per element, greatly increasing the complexity of the circuit. Another full-duplex system utilized an AM diode detector and clipper circuit to separately recover the data and generate a carrier to be used for phase conjugation. However, this technique is limited to AM modulation only.

A second issue regarding system efficiency is ensuring that the power of the retrodirected signal remains constant. Therefore, the power of the signal must be made independent of the power received from the interrogator. However, in many of the conventional designs, as illustrated in FIG. 1(a), when a retrodirective array is interrogated by a strong signal, a relatively weak retrodirected signal may be transmitted back to the source. This is due to the fact that the signal must travel a roundtrip distance of 2R, resulting in the power of the signal being reduced by a factor of 1/R⁴. As a result, the retrodirected power transmitted back to source B, which is farther away than source A, will be less than that transmitted to source A. In practice, however, a strong and constant retrodirected power level is desired, independent of the distance of the interrogating source. Techniques such as inserting a bidirectional amplifier in a Van Atta array or designing mixers with conversion gain in a phase-conjugating array can help, but still does not ensure a constant retrodirected power level.

One way to maintain a constant retrodirected power level is to incorporate phase lock loops (PLLs) into a phase-conjugating array. As illustrated in FIG. 1(b), as long as the power of the interrogating signal is within the PLL's locking range, the power of the retrodirected signal will be independent of the power of the interrogating signal. This reduces the power loss in the signal as the power of the retrodirected signal received at the source can be made proportional to approximately 1/R². PLLs have been incorporated into the phase-conjugating circuit to form a phase-conjugating lock loop, eliminating the need for mixers. However, the disadvantage of using PLLs in a retrodirective array is the large size and complexity of the PLL circuitry at each element.

### SUMMARY OF INVENTION

The present invention provides a novel approach for implementing a retrodirective array that is capable of both full-duplex communication and maintaining a constant retrodirected power level. By using a phase detector to detect the incoming angle of the interrogating source, phase shifters on a transmitting array are automatically controlled to retrodirect a beam back in the direction of the source. In addition to generating a retrodirected signal in the transmitting array, phase shifters in the receiving array ensure coherent combination of the interrogating signal for full-duplex communication. The invention design uses only a fraction of the components required for a PLL-based array. Since the transmitter and receiver arrays are RF decoupled, the frequency of the interrogator signal can be distinct from the retrodirected frequency. This has the potential of greatly increasing the efficiency of the system requiring a high-frequency retrodirected signal by using an interrogator signal at a much lower frequency. Another advantage of this decoupled approach is that increasing directivity requires adding elements only on the transmitting and receiving array, since the two-element angle detecting array is sufficient for detecting the direction of the source. Since the source angle is determined by measuring the phase difference between two elements, the angle detecting array is insensitive to the type of modulation used for the incoming signal.

Other objects, features, and advantages of the present invention will be explained in the following detailed description of the invention having reference to the appended drawings.

### BRIEF DESCRIPTION OF DRAWINGS

FIG. 1(a) illustrates a retrodirected signal being weaker than an interrogator signal particularly on return to a source farther away, as compared to FIG. 1(b) showing a constant retrodirected signal power that is independent of interrogator signal power.

FIG. 2 shows a design for a self-steering retrodirective array using phase detecting and phase shifting to obtain constant transmit power and full-duplex communication.

FIG. 3 shows measured error voltage Vₑᵣᵣ plotted versus phase difference φᵣ (A_{d}=1) of the phase detector at 1.425 GHz for the Receiving Array.

FIG. 4 shows a two-port phase shifter comprised of two reflective networks that are combined using a 90° hybrid.

FIG. 5 shows a plot of phase shift φₜ and insertion loss versus control voltage Vₜ for the 2.85 GHz phase shifter.

FIG. 6 shows a plot of phase shift φᵣ and insertion loss versus control voltage Vᵣ for the 1.425 GHz phase shifter.

FIGS. 7 and 8 show test measurement setups for the self-steering functions of the Transmitter and Receiver Array through bistatic and monostatic radiation pattern measurements.

FIGS. 9a, 9b, 9c show retrodirectivity measurements of magnitude (dB) for interrogating angles of (a) 0°, (b) −15° and (c) +25°, respectively.

FIG. 10 shows the measured received power of the two-element phase detecting/shifting Receiver Array compared to a conventional two-element reference array.

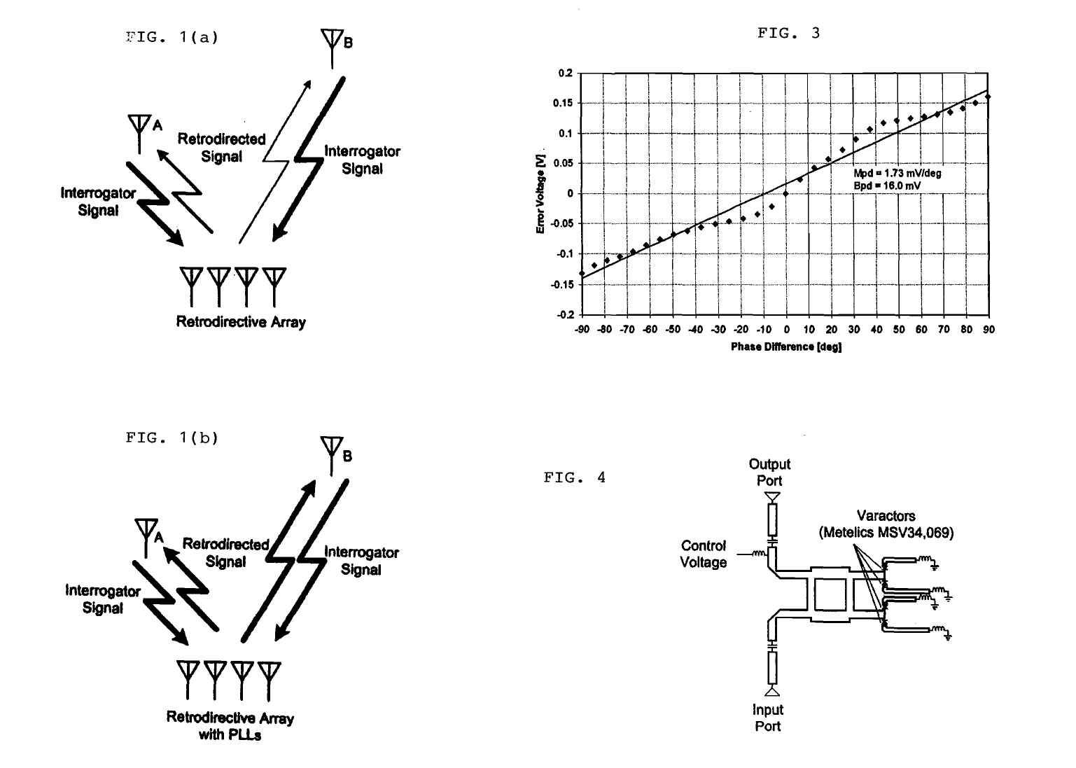

### DETAILED DESCRIPTION OF INVENTION

In the following detailed description of the invention, certain preferred embodiments are illustrated providing certain specific details of their implementation. However, it will be recognized by one skilled in the art that many other variations and modifications may be made given the disclosed principles of the invention.

In accordance with the invention, a design for a self-steering retrodirective array using phase detecting and phase shifting to obtain constant transmit power and full-duplex communication is shown in FIG. 2 broken up into three parts. First, the antenna elements 10 of a two-element Angle-Detecting Array (A) are connected to a phase detector 20 where the direction of the incoming signal is derived via a differential amplifier 22 as an output error voltage Vₑᵣᵣ. Next, a self-steering array can be realized by using this error voltage to control a simple, varactor-based phase shifter 50 on a Transmitting Array (C) to direct a transmitted signal from antenna elements 60 back to the original source. Finally, a Receiving Array (B) can utilize the error voltage of the phase detector 20 via an amplifier 34 as an input to a phase shifter 30 which is operable with a delay line 32 to ensure that the incoming signal is always combined in phase.

The resulting circuit is much simpler than a PLL-based phase-conjugating array since it only requires one phase detector and no voltage-controlled oscillators. As long as the power of the interrogating signal is within the phase detector's locking range, the retrodirected signal will be transmitted back to the interrogator at a constant power level and modulation, as determined by the RF source. When dealing with extremely weak signals, it is possible to enhance the detecting threshold by inserting low-noise amplifiers (LNAs) between the antenna and phase detector.

A. Angle-Detecting Array

The operation of the Angle-Detecting Array shown in FIG. 2 can be understood by looking at the phase difference φᵣ generated by an incoming plane wave at angle θᵣ, for an array spaced d=λ/2 apart:

$$\begin{matrix}{ϕ}_{r} = kd sin {θ}_{r} \\ = {πsinθ}_{r} \\ \end{matrix} \qquad ( 1 )$$

Assuming the phase detector has a linear voltage/phase relationship, the error voltage Vₑᵣᵣ is approximated by
Vₑᵣᵣ≈A_{d}(M_{pd}φᵣ+B_{pd}) (2)
where A_{d} [VN] is the gain of the differential amplifier, M_{pd} [V/deg] is the sensitivity of the phase detector and B_{pd} [V] is the error voltage at the zero phase difference point. This error voltage is used to point the beam of the transmitting array back in the direction of the source and ensures that the received signal is combined in phase.
B. Transmitting Array

Since the error voltage from the differential amplifier, Vₑᵣᵣ, can take on both positive and negative values, it would be unsuitable to directly control the varactor-based phase shifter on the Transmitting Array, which must always be maintained in reverse bias. Therefore, a dc offset voltage V₀ₜ is added to Vₑᵣᵣ through a summing amplifier with gain Aₜ [V/], to ensure that the varactor does not become forward biased:
Vₜ=Aₜ(Vₑᵣᵣ+Vₒₜ) (3)

Assuming a linear phase shift/voltage relationship, the output of the phase shifter φₜ is approximated by:
φₜ≈SₜVₜ+ψₜ (4)
where Sₜ [deg/V] is the sensitivity of the phase shifter and ψₜ [deg] is the phase when Vₜ=0.

If the transmitting array elements are spaced λ/2 apart, the RF signal will be transmitted in the direction given by equation (5), where φ₀ₜ is the length of a delay line that is inserted to ensure that the mainbeam of the Transmitting Array is broadside when Vₜ is in the middle of the phase shifter's control range (i.e., 12.5 V).

$${θ}_{t} = {sin}^{- 1} ( \frac{{ϕ}_{t} - {ϕ}_{ot}}{π} ) \qquad ( 5 )$$

In most systems, the characteristics of the phase detector and phase shifter M_{pd}, Sₜ, B_{pd}, and ψₜ are predetermined. Therefore, it is easier to tune the gain of the summing amplifier Aₜ and the length of the delay line ψ₀ₜ. Combining equations (2)-(5) for θₜ=θᵣ and solving for A_{d} results in:

$${A}_{d} = - \frac{{A}_{t} {S}_{t} {V}_{ot} + {ψ}_{t} - {ϕ}_{ot} - {ϕ}_{r}}{{A}_{t} {S}_{t} ( {B}_{pd} + {M}_{pd} {ϕ}_{r} )} \qquad ( 6 )$$

A_{d} can be made independent of φₚ by setting

$$\frac{\partial }{\partial {ϕ}_{r}} {A}_{d} = 0 \qquad ( 7 )$$

and solving for φ₀ₜ

$${ϕ}_{ot} = \frac{{A}_{t} {M}_{pd} {S}_{t} {V}_{ot} + {B}_{pd} + {ψ}_{t} {M}_{pd}}{{M}_{pd}} \qquad ( 8 )$$

Substituting equation (8) into equation (6) for φ₀ₜ, the resulting equation for Aₜ is:

$${A}_{t} = \frac{1}{{A}_{d} {M}_{pd} {S}_{t}} \qquad ( 9 )$$

The expressions (8) and (9) are the design equations that are used for the invention design.
C. Receiving Array
The design of the Receiving Array is very similar to the Transmitting Array except that the purpose of the phase shifter in this array is now to ensure that the received signal combines in phase at the receiver port. This condition is satisfied when:
φᵣ=φᵣ₁−φ₀ᵣ (10)
where φᵣ₁ is the phase shift of the receiver phase shifter and φ₀ᵣ is the length of a delay line which is inserted to ensure that Vᵣ is in the middle of the phase shifter's control range (i.e., 10 V) when the signal is combined in phase.

An alternative approach to rederiving the design equations for the Receiver Array is to note that the condition of θₜ=θᵣ for the Transmitting Array implies
φᵣ=φₜ−φ₀ₜ (11)
Therefore, the length of the delay line θ₀ᵣ can be found by replacing Aₜ, Sₜ, V₀ₜ, and ψₜ in equation (8) with Aᵣ, Sᵣ, V₀ᵣ, and ψᵣ respectively:

$${ϕ}_{or} = \frac{{A}_{r} {M}_{pd} {S}_{r} {V}_{or} + {B}_{pd} + {ψ}_{r} {M}_{pd}}{{M}_{pd}} \qquad ( 12 )$$

and the gain of the receiver summing amplifier Aᵣ [V/] is given by replacing Sₜ in equation (9) with Sᵣ,

$${A}_{r} = \frac{1}{{A}_{d} {M}_{pd} {S}_{r}} \qquad ( 13 )$$

where Sᵣ [deg/V] is the sensitivity of the phase shifter for the receiver may and ψᵣ [deg] is the phase when Vᵣ=0.

### EXAMPLE

An example of the self-steering system was tested and the results are summarized below. The Angle-Detecting Array part of the 3-stage system (see FIG. 2) consisted of two radiating-edge fed microstrip patch antennas, spaced λ/2 apart at 1.425 GHz, and fabricated on RT/duroid 5880 substrate (thickness 0.7874 mm, ξᵣ=2.2). A Hittite(TM) HMC403S8G phase detector was used to detect the phase difference of the interrogating signal between the two elements of the Angle Detecting Array. To match the width of the 50-ohm transmission lines to the smaller pins of an S8G package, the phase detector was mounted on a thinner RT/duroid 5880 substrate (thickness 0.254 mm, ξᵣ=2.2). The differential amplifier used an Analog Devices OP-275 unit in an instrumentation amplifier configuration. This configuration complemented the output stage of the phase detector with its large input resistance in addition to having good common-mode rejection.

The sensitivity of the phase detector M_{pd} is found experimentally by interrogating the Receiving Array with a source from −30°≦θᵣ≦30°. Using equation (1), the measured error voltage Vₑᵣᵣ is plotted versus the phase difference φᵣ (A_{d}=1) of the phase detector at 1.425 GHz, as shown in FIG. 3. A best-fit line is calculated using the least squares method. The resultant is the measured values for M_{pd} and B_{pd}.

The Transmitting Array consisted of two radiating-edge fed microstrip patch antennas, spaced λ/2 apart at 2.85 GHz, and fabricated on RT/duroid 5880 substrate (thickness 0.7874 mm, ξᵣ=2.2). A reflection-type phase shifter is fabricated at 2.85 GHz to perform the beam steering of the transmitted RF signal. Each section of the phase shifter consists of a pair of reverse-biased Metelics(TM) MSV34,069 varactor diodes with open-circuit stubs that are connected in parallel to form a 360° reflective network.

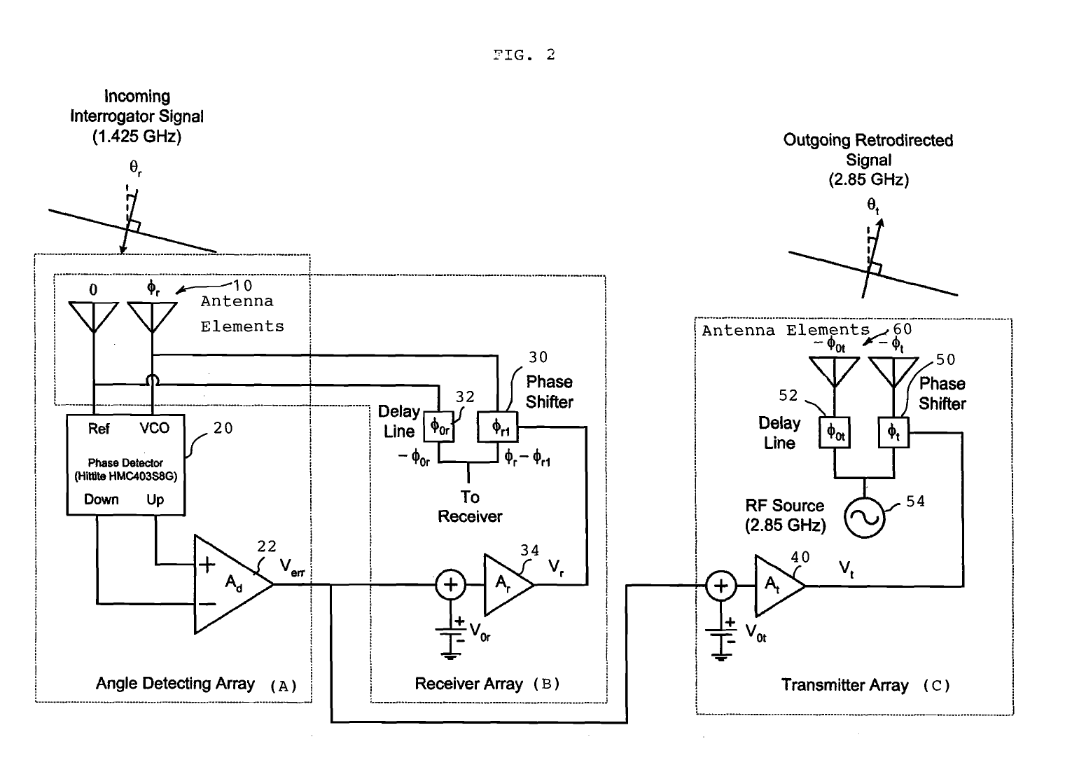

FIG. 4 shows a two-port phase shifter comprised of two reflective networks that are combined using a 90° hybrid. The phase shifter is designed for a linear 360° phase shift with a control voltage of 5 to 20 V and is fabricated on RT/duroid 5880 substrate (thickness 0.7874 mm, ξᵣ=2.2).

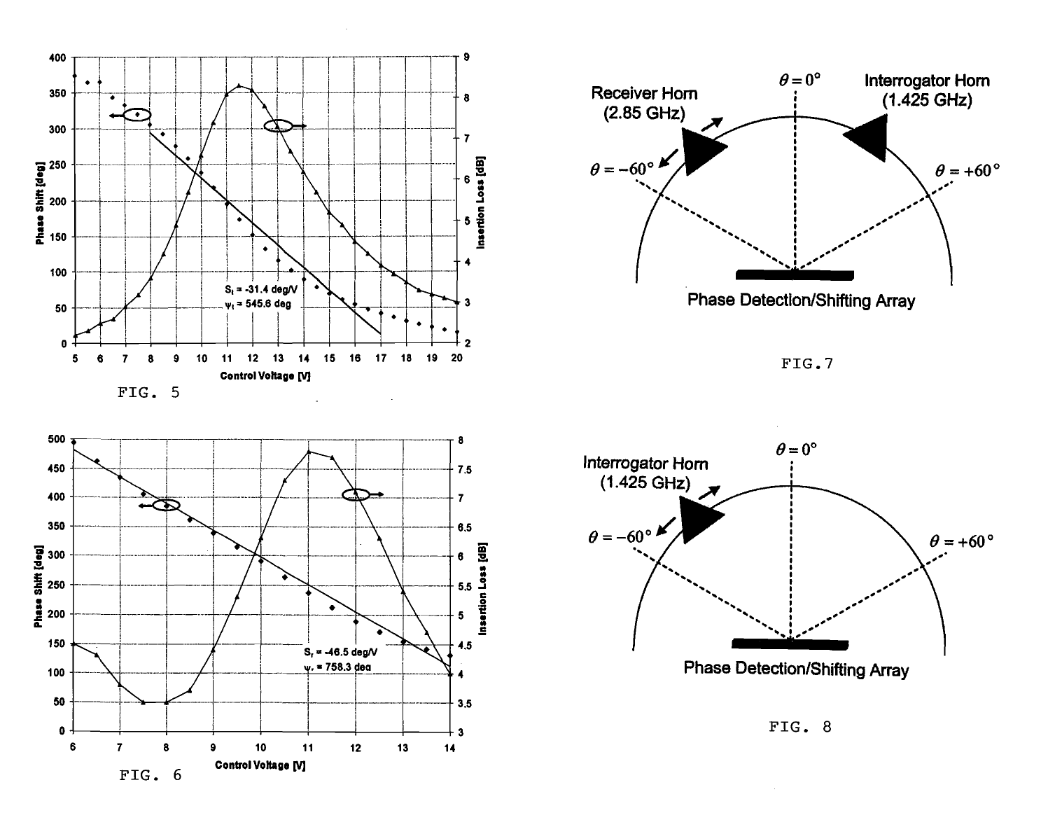

FIG. 5 shows a plot of phase shift φₜ versus the control voltage Vₜ for the 2.85 GHz phase shifter. Assuming a scanning range of −30°≦θᵣ≦30° to avoid beam pointing errors, a best-fit line is calculated for 8 V≦Vₜ≦17 V. Sₜ=−31.4 deg/V and ψₜ=545.6° is the resultant slope and y-intercept of the line.

The value of V₀ₜ is set so that Vₜ will be in the middle of the 8 to 17 V range when Vₑᵣᵣ=0. Using a unity gain differential amplifier (A_{d}=−1), V₀ₜ=12.5 V. Substituting this value into equations (8) and (9) gives φ₀ₜ 162.3° and Aₜ=18.4 V/V. To compensate for the insertion loss of the phase detector, attenuators are inserted as part of the delay line (pot to balance the amplitude of the array.

Power is coupled from each element of the Angle Detecting Array to form the Receiving Array. The phase shifter used for the Receiving Array was designed in the same fashion as the Transmitting Array (FIG. 4) with the exception of using M/A-COM MA46505 varactor diodes.

FIG. 6 shows a plot of phase shift φᵣ and insertion loss versus the control voltage Vᵣ for the 1.425 GHz phase shifter. A best-fit line is calculated for 6 V≦Vᵣ≦14 V. Sᵣ=−46.5 deg/V and ψₜ=545.6 deg is the resultant slope and y-intercept of the line. The value of V₀ᵣ is set so that Vᵣ will be in the middle of the 6 to 14 V range when Vₑᵣᵣ=0. Using a unity-gain differential amplifier (A_{d}=−1), V₀ᵣ=10.0 V. Substituting into equation (12) and (13) gives φ₀ᵣ=302.5 deg and Aᵣ=12.7 V/V. To compensate for the insertion loss of the receiver phase detector, 6 dB of attenuation is inserted as part of the delay line to balance the amplitude of the array. This is done for demonstration purposes so that the measured ripple in the receive power versus interrogation angle will be less dependent on the curve of the phase shifter's insertion loss. Ideally, the delay line should have zero attenuation to complement a phase shifter with minimal insertion loss.

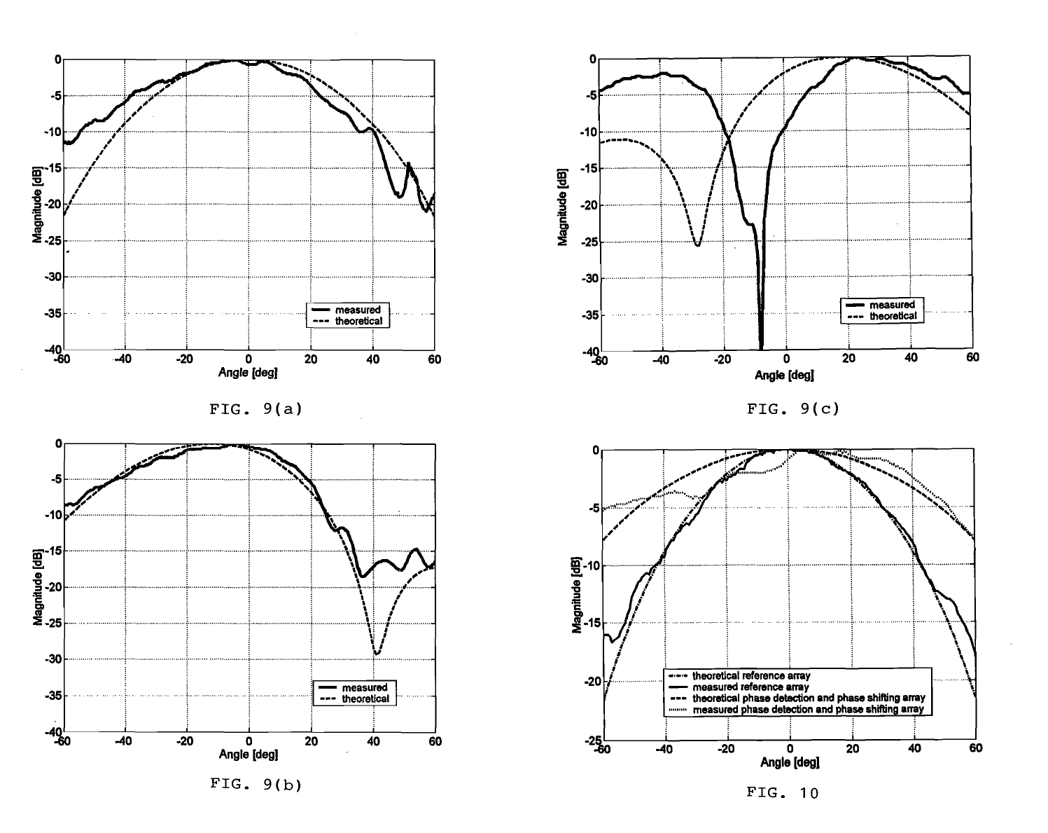

The test measurement setups for the self-steering and receiving functions are shown in FIGS. 7 and 8. Self-steering or retrodirectivity of the Transmitter Array is confirmed through the bistatic radiation pattern measurement. In the bistatic measurement, the position of the 1.425 GHz interrogating horn is fixed, while a second receiving horn is mounted on a computer-controlled rotational arm, measuring the 2.85 GHz retrodirected signal from −60°≦θ≦60°. In each case, the Angle Detecting Array detects the angle of the source and steers the beam of the Transmitting Array to the direction of the source. The theoretical and measured bistatic radiation patterns shown in FIGS. 9a, 9b, 9c of magnitude (dB) confirm retrodirectivity for interrogating angles of (a) 0°, (b) −15° and (c) +25°, respectively.

Performance of the Receiving Array is evaluated by measuring the received power at the receiver array port for interrogating angles of −60°≦θ≦60°. Since the circuit of the Receiver Array is designed to ensure that the signal from each element combine in phase, there should be no nulls observed in the received power due to the array factor.

FIG. 10 shows the measured received power of the two-element phase detecting/shifting Receiver Array compared to a conventional two-element reference array. By observing the general curve of the phase detection and phase shifting Receiver Array, it can be seen that the receive pattern is more omnidirectional when compared to the reference array, resulting in up to a 12 dB improvement in received signal power. The measured ripple is due to the ripple in the insertion loss of the phase detector of the receiver array (FIG. 6) and can be remedied by better matching the reflective networks of the phase shifter to the hybrid coupler. A significant improvement would be observed for receiving arrays with four or more elements, as the nulls caused by the array factor would be present in the −60°≦θ≦60° scanning range for a conventional array, but compensated for in the phase detection and phase shifting receiving array.

In summary, a full-duplex dual-frequency self-steering array using phase detection and phase shifting operates by RF de-coupling of the transmitter and receiver arrays, in order to obtain greater system efficiency by ensuring a constant transmit power. This also allows for a separate, low-frequency interrogating signal, capable of various modulation schemes. A two-element example built with an interrogating and retrodirective frequencies of 1.425 GHz and 2.85 GHz, respectively, showed retrodirectivity for angles of 0°, −15°, and +25°. The power of the received signal was improved by up to 12 dB for −60°≦θ≦60° when compared to a conventional two-element array.

It is to be understood that many modifications and variations may be devised given the above description of the principles of the invention. It is intended that all such modifications and variations be considered as within the spirit and scope of this invention, as defined in the following claims.

1. A self-steering retrodirective array comprising:
(a) an angle-detecting array having a phase detector for detecting angle orientation of an incoming signal from a signal source and providing an output of an error voltage signal indicative of phase detected,
(b) a receiving array coupled to the output error voltage signal of said angle-detecting array and including a phase shifter for ensuring that the incoming signal is combined in phase, and
(c) a transmitter array for directing a transmitted signal back to the signal source at the same angle orientation as the incoming signal, said transmitter array being coupled to the output error voltage signal of said angle-detecting array and having a phase shifter for ensuring that the transmitted signal is transmitted in phase.

2. A self-steering retrodirective array according to claim 1, wherein said receiving array and said transmitter array are RF-decoupled for full-duplex communication.

3. A self-steering retrodirective array according to claim 1, wherein said receiving array receives an incoming signal of a different frequency from the transmitted signal transmitted by said transmitter array for full-duplex communication.

4. A self-steering retrodirective array according to claim 1, wherein said transmitter array has a varactor-based phase shifter which is controlled by the output error voltage signal.

5. A self-steering retrodirective array according to claim 1, wherein said angle-detecting array is configured such that the power of the incoming signal is within the phase detector's locking range, and said transmitter array is configured such that the retrodirected transmitted signal is transmitted back to the source at a constant power level.

6. A self-steering retrodirective array according to claim 1, wherein said angle-detecting array has two radiating-edge fed microstrip patch antennas, and the phase detector is used to detect the phase difference of the incoming signal between the two antennas.

7. A self-steering retrodirective array according to claim 1, wherein said transmitting array has two radiating-edge fed microstrip patch antennas, and the phase shifter is a reflection-type phase shifter used to perform the beam steering of the transmitted signal.

8. A self-steering retrodirective array according to claim 1, wherein said angle-detecting array is configured to detect an incoming signal frequency in the 1.425 GHz range.

9. A self-steering retrodirective array according to claim 1, wherein said transmitter array is configured to transmit a transmitted signal frequency in the 2.85 GHz range.

10. A self-steering retrodirective array according to claim 1, wherein said angle-detecting array has two radiating-edge fed microstrip patch antennas and is configured to detect an incoming signal frequency in the 1.425 GHz range, and the power of phase detection and shifting of the received incoming signal was improved by up to 12 dB for a scanning range of −60°≦θ≦60° when compared to a conventional two-element retrodirective array.

11. A method of operating a self-steering retrodirective array comprising:
(a) receiving an incoming signal from a signal source,
(b) using a phase detector for detecting angle orientation of the incoming signal and providing an output of an error voltage signal indicative of phase detected,
(c) coupling the output error voltage signal to a phase shifter for generating a transmitted signal in the same phase as the incoming signal, and
(d) transmitting the transmitted signal back to the signal source at the same angle orientation as the incoming signal.

12. A method of operating a self-steering retrodirective array according to claim 11, wherein said receiving step and said transmitting step are RF-decoupled for full-duplex communication.

13. A method of operating a self-steering retrodirective array according to claim 11, wherein the incoming signal is of a different frequency from the transmitted signal for full-duplex communication.

14. A method of operating a self-steering retrodirective array according to claim 11, wherein the retrodirected transmitted signal is transmitted back to the source at a constant power level.

15. A self-steering retrodirective array comprising:
(a) an angle-detecting array having a phase detector for detecting angle orientation of an incoming signal from a signal source and providing an output of an error voltage signal indicative of phase detected, and
(b) a transmitter array for directing a transmitted signal back to the signal source at the same angle orientation as the incoming signal, said transmitter array being coupled to the output error voltage signal of said angle-detecting array and having a phase shifter for ensuring that the transmitted signal is transmitted in phase.

16. A self-steering retrodirective array according to claim 15, wherein said angle-detecting array has two radiating-edge fed microstrip patch antennas, and the phase detector is used to detect the phase difference of the incoming signal between the two antennas.

17. A self-steering retrodirective array according to claim 15, wherein said

17. A self-steering retrodirective array according to claim 15, wherein said transmitting array has two radiating-edge fed microstrip patch antennas, and the phase shifter is a reflection-type phase shifter used to perform the beam steering of the transmitted signal.

18. A self-steering retrodirective array according to claim 15, wherein said angle-detecting array is configured to detect an incoming signal frequency in the 1.425 GHz range.

19. A self-steering retrodirective array according to claim 15, wherein said transmitter array is configured to transmit a transmitted signal frequency in the 2.85 GHz range.

20. A self-steering retrodirective array according to claim 15, wherein said angle-detecting array has two radiating-edge fed microstrip patch antennas, the phase detector receives inputs from the two antennas and generates a phase difference signal indicative of the angle of the incoming signal's plane wave, and the phase difference signal is fed to a differential amplifier to generate the output error voltage signal.
